(19) United States
(12) Patent Application Publication
(10) Pub. No.: US 2013/0322142 A1
(43) Pub. Date: Dec. 5, 2013

(54) MULTILEVEL POWER CONVERTER

(71) Applicant: Ravisekhar Nadimpalli Raju, Clifton Park, NY (US)

(72) Inventor: Ravisekhar Nadimpalli Raju, Clifton Park, NY (US)

(73) Assignee: GENERAL ELECTRIC COMPANY, SCHENECTADY, NY (US)

(21) Appl. No.: 13/484,517

(22) Filed: May 31, 2012

(51) Int. Cl. H02M 7/12; H02M 7/06

(52) U.S. Cl. 363/126

(57) ABSTRACT

An AC-DC power converter is provided. The power converter includes an electrical terminal including a positive node and a negative node. The power converter also includes a first switch coupled across the positive node and the negative node and a second switch coupled in a reverse orientation relative to the first switch and in parallel to the first switch forming a first path and a second path. The power converter further includes a first electrical storage device situated in the first path and a second electrical storage device situated in the second path.

### BACKGROUND

The invention generally relates to power conversion systems and, more particularly, to a multilevel power conversion system.

There is a growing need to transmit power over long distances using high voltage DC (HVDC). Power converters are often used to convert AC power to DC power at the transmitting substation and to convert the transmitted DC power back to AC power at the receiving substation. In one approach, these power converters have a modular multilevel structure where each phase has a stacked arrangement of modules.

Some multilevel power converters comprise modules that consist of a half-bridge of two switches coupled across a capacitor. The switches in the half-bridge are often semiconductors such as insulated gate bipolar transistors (IGBTs). The IGBT chips in each module are mounted on a baseplate and heat sink with an electrically insulating substrate such as aluminum nitride for cooling. The thickness of the insulation substrate is determined based on the peak voltage present across the collectors of the switches. In embodiments that use a half-bridge across a capacitor, the full capacitor voltage may appear across the collectors of the switches, and thus insulation substrates having increased thicknesses are required. Increasing the thickness of the insulation substrate raises the thermal resistance and reduces the effectiveness of the heat sink and thus the performance of the power converter. In addition, in such embodiments, control power required for the gating and sensing electronics is extracted from the capacitor coupled to the switches. Since the peak voltage at the capacitor is high, high voltage DC-DC converters are required to extract control power. Such high voltage DC-DC converters are bulky and increase system expense.

Hence, there is a need for an improved system to address the aforementioned issues.

### BRIEF DESCRIPTION

Briefly, in accordance with one embodiment, an AC-DC power converter is provided. The power converter includes an electrical terminal comprising a positive node and a negative node. The power converter also includes a first switch coupled across the positive node and the negative node. The power converter also includes a second switch coupled in a reverse orientation relative to the first switch and in parallel to the first switch forming a first path and a second path. The power converter further includes a first electrical storage device situated in the first path and a second electrical storage device situated in the second path.

In another embodiment, a power conversion system is provided. The power conversion system includes phase units wherein each phase unit comprises an upper converter arm and a lower converter arm configured to convert power for a distinct phase of an input power wherein each converter arm comprises power modules coupled in series to each other and each module comprises a power converter. Each of the power converters includes an electrical terminal comprising a positive node and a negative node. The power converters also include a first switch coupled across the positive node and the negative node. The power converters also include a second switch coupled in a reverse orientation relative to the first switch and in parallel to the first switch forming a first path and a second path. The power converters further include a first electrical storage device situated in the first path and a second electrical storage device situated in the second path.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic representation of a conventional power converter comprising one capacitor and two switches in a half-bridge configuration.

FIG. 2 is a graphical representation of a voltage waveform appearing across the collectors of the half-bridge switches in a conventional power converter when the switches are turned on and off alternatively.

FIG. 3 is a schematic representation of a conventional power converter wherein the two switches in the half-bridge configuration are coupled to a baseplate and a heat sink through an insulation substrate comprising a thickness T at the collectors of the switches.

FIG. 4 is a schematic representation of a power converter including two energy storage devices and two switches in accordance with an embodiment of the invention.

FIG. 5 is a graphical representation of the voltage appearing across the collectors of the two switches in a power converter in accordance with an embodiment of the invention.

FIG. 6 is a schematic representation of a power converter including two energy storage devices and two switches, wherein the two switches are coupled to an insulation substrate comprising a thickness Tnew at the collector of the switches in accordance with an embodiment of the invention.

FIG. 7 is a block diagram representation of a power conversion system including power converter modules wherein each of the power converter modules includes a power converter in accordance with an embodiment of the invention.

### DETAILED DESCRIPTION

Unless defined otherwise, technical and scientific terms used herein have the same meaning as is commonly understood by one of ordinary skill in the art to which this disclosure belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced items. The term “or” is meant to be inclusive and mean one, some, or all of the listed items. The use of “including,” “comprising” or “having” and variations thereof herein are meant to encompass the items listed thereafter and equivalents thereof as well as additional items. The terms “connected” and “coupled” are not restricted to physical or mechanical connections or couplings, and can include electrical connections or couplings, whether direct or indirect. Furthermore, the terms “circuit,” “circuitry,” “controller,” and “processor” may include either a single component or a plurality of components, which are either active and/or passive and are connected or otherwise coupled together to provide the described function.

Embodiments of the present invention include a power converter that includes an electrical terminal including a positive node and a negative node. The power converter also includes a first switch coupled across the positive node and the negative node. The power converter also includes a second switch coupled in a reverse orientation relative to the first switch and in parallel to the first switch forming a first path and a second path. The power converter further includes a first electrical storage device situated in the first path and a second electrical storage device situated in the second path. In one embodiment, the power converter can be used for high power applications in which each of a plurality of power converters is configured to form a module and multiple modules are coupled together to form a modular stacked high power converter.

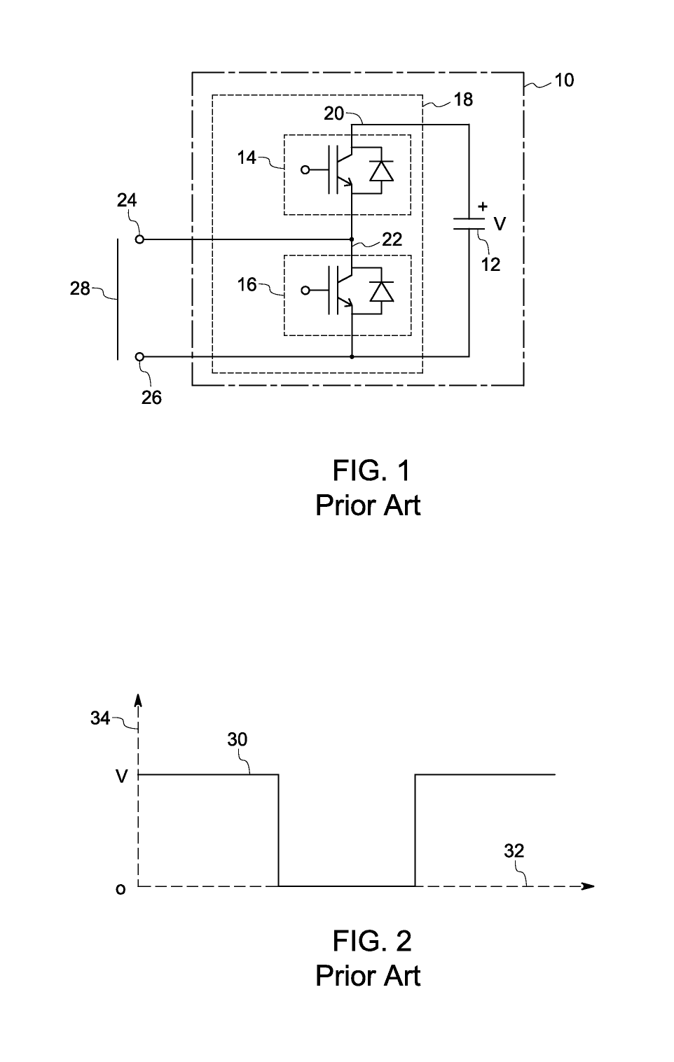

FIG. 1 is a schematic representation of a conventional power converter 10 comprising one capacitor 12 and two switches 14, 16 in a half-bridge configuration 18. The half-bridge configuration 18 consists of two switches 14, 16 that are connected in series. The anode or collectors 20, of switch 14 is connected to the positive terminal of the capacitor 12 and the cathode or emitter of switch 16 is connected to the negative terminal of the capacitor 12. Terminal 24 of the power converter 10 is connected to the mid-point of the half-bridge 18 and terminal 26 is connected to the cathode or collector of switch 16. Output voltage 28 across the power converter 10 is maintained substantially at zero when switch 16 is closed or at the capacitor voltage when switch 14 is closed.

FIG. 2 is a graphical representation of a voltage waveform 30 across the collectors 20 and 22 (FIG. 1) of switches 16 and 18 (FIG. 1) respectively of the conventional power converter 10 shown in FIG. 1. X-axis 32 represents time and Y-axis 34 represents voltage. As illustrated, the voltage level is substantially equal to the capacitor voltage V when switch 14 is closed or zero when switch 16 is closed.

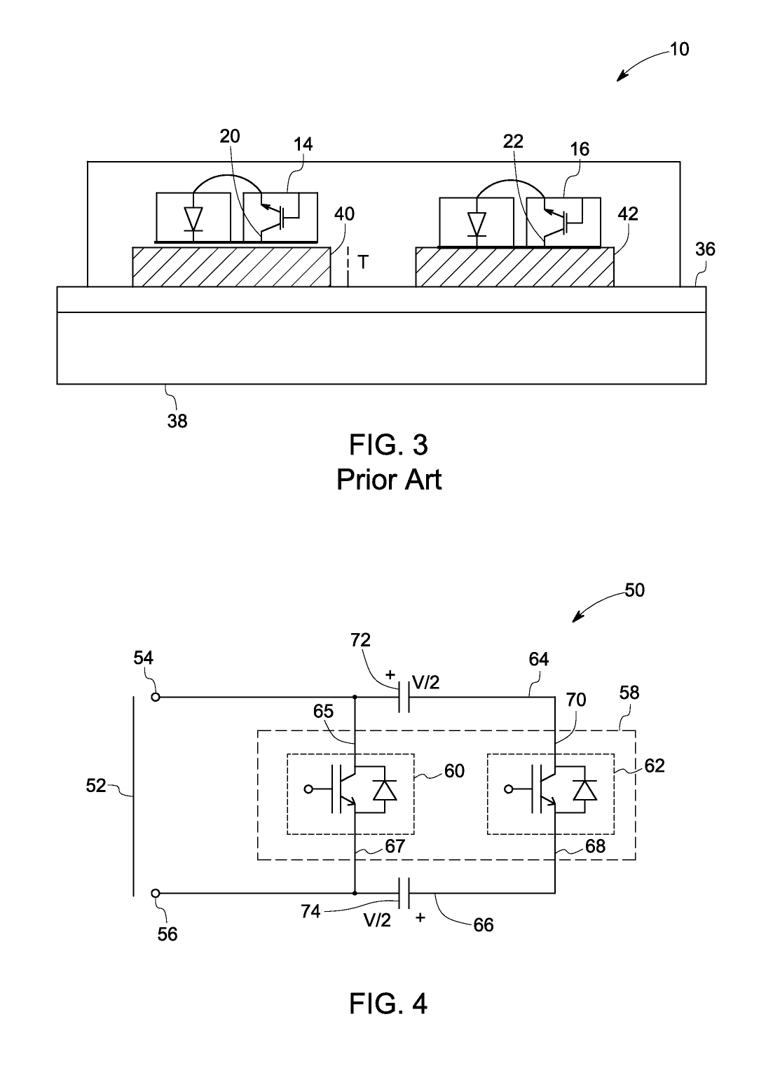

FIG. 3 is a schematic representation of the conventional power converter 10 wherein the two switches 14, 16 in the half-bridge configuration 18 (FIG. 1) are coupled to insulation substrates 40 and 42 comprising a thickness T at the collectors of the switches 14, 16. The insulation substrates 40 and 42 are disposed on the baseplate 36 and the heat sink 38 that is configured to reduce an operating temperature of the switches 14, 16. The conventional power converter 10 includes one capacitor ((not shown in FIG. 3)) coupled to two switches 14, 16 resulting in the voltage across the collectors equal to the capacitor voltage or peak output voltage. The voltage stress on the insulation substrates 40 and 42 is high, and the insulation substrates have a thickness T that is required for preventing any voltage breakdown.

FIG. 4 is a schematic representation of a power converter 50 in accordance with an embodiment of the invention. The power converter 50 includes an electrical terminal 52 including a positive node 54 and a negative node 56. In one embodiment, the electrical terminal 52 comprises an output terminal. The power converter 50 includes a switching arrangement 58 that has a first switch 60 and a second switch 62 coupled in parallel to each other to form a first path 64 and a second path 66. In a specific embodiment, the switches 60, 62 comprise insulated gate bipolar transistors. The first switch 60 includes an anode or collector leg 65, and a cathode or emitter leg 67, that are coupled respectively to the positive node 54 and the negative node 56 of the electrical terminal 52. The anode or collector 68 and the cathode or emitter 70 of the second switch 62 are coupled in a reverse orientation with respect to the first switch 60 and are coupled to the negative node 56 and the positive node 54 respectively. A first energy storage device 72 is coupled in the first path 64, and a second energy storage device 74 is coupled in the second path 66. In a specific embodiment, the energy storage devices 72, 74 include capacitors that are maintained at substantially equal voltages.

In operation, due to coupling of the first energy storage device 72 to the first path 64 and the second energy storage device 74 to the second path 66, the peak value of voltage between the collectors of the first switch 60 and the second switch 62 is equal to an individual capacitor voltage, i.e, half of the output voltage, thus reducing the voltage stress on the insulation substrate as compared to the conventional power converters discussed in FIG. 1.

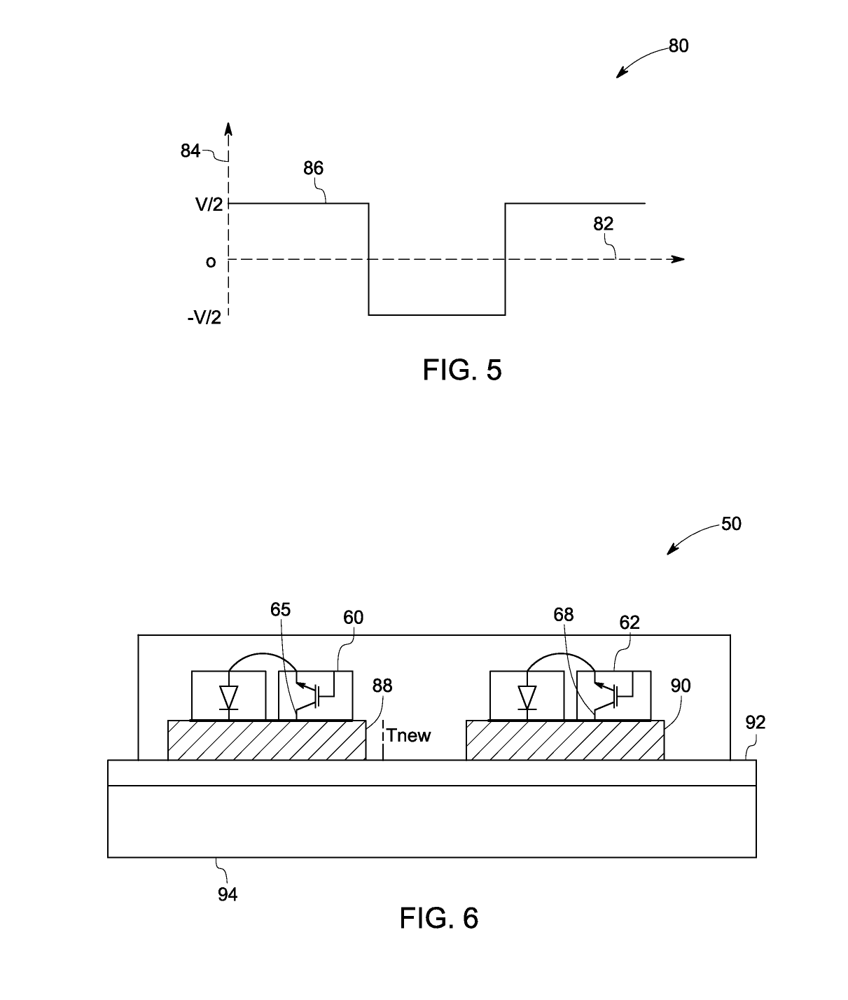

FIG. 5 is a graphical representation 80 of the voltage appearing across the collectors of the two switches in the power converter 50 (FIG. 4) in accordance with an embodiment of the invention. X-axis 82 depicts time and Y-axis 84 depicts voltage. Curve 86 represents the voltage across the collectors in the power converter 50. As illustrated, the voltage across the collectors is substantially equal to the voltage of the energy storage device 72 when switch 62 is closed and equal to the voltage of the energy storage device 74 in reverse when switch 60 is closed. Thus the voltage across the collectors can be limited to half the net output voltage.

FIG. 6 is a schematic representation of the power converter 50 (FIG. 4) including two energy storage devices 72, 74 (FIG. 4) and two switches 60, 62, wherein the two switches 60, 62 are coupled to insulation substrates 88, 90 comprising a thickness Tnew at the collectors 65, 68 of the switches 60, 62 in accordance with an embodiment of the invention. As discussed in FIG. 4, the voltage stress on the insulation substrates 88, 90 reduces as the peak voltage across the collectors is equal to half of the output voltage, the thickness of the insulation substrates 88, 90 can thus be reduced to Tnew wherein Tnew is lesser than T (FIG. 3). The insulation substrates 88 and 90 are disposed on a baseplate 92 and a heat sink 94 that is configured to reduce the operating temperatures of the first switch 60 and the second switch 62. The heat sink 94 operates more efficiently as the distance (Tnew) between the heat sink 94 and the switches 60, 62 is reduced. Moreover, smaller DC-DC converters (not shown) may be used for stepping down the DC voltage from individual energy storage elements 72, 74 for providing power for gating controls of the switches 60 and 62 during operation.

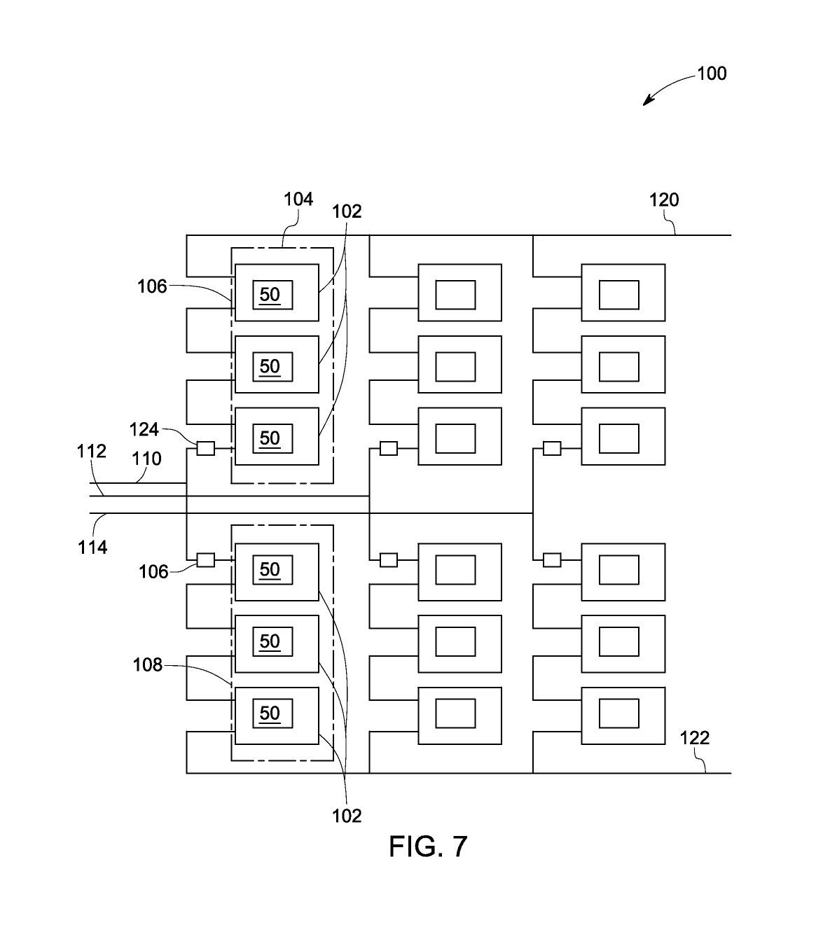

FIG. 7 is a block diagram representation of a power conversion system 100 including power converter modules 102. The power conversion system 100 includes phase units 104 for each phase of power. In one embodiment, the phase units 104 are coupled in parallel. In a more specific embodiment, the power conversion system 100 includes a modular stacked power conversion system. Each of the phase units 104 includes an upper converter arm 106 and a lower converter arm 108 that convert power for a distinct phase of an input power. Terminals 110, 112, 114 are three-phase AC terminals and terminals 120, 122 are DC terminals. In one embodiment, the upper converter arm 106 and the lower converter arm 108 are coupled in series through inductive filter elements 124 and 126. Each of the converter arms 106, 108 further includes power converter modules 102 that are coupled in series to each other. As discussed above, each of the power converter modules 102 includes the electrical terminal 52 (FIG. 4) comprising the positive node 54 (FIG. 4) and the negative node 56 (FIG. 4). The power converter module 102 also includes the switches 60, 62 and the energy storage devices 72 and 74 coupled in the configuration 58 as described in FIG. 4 above.

It is to be understood that a skilled artisan will recognize the interchangeability of various features from different embodiments and that the various features described, as well as other known equivalents for each feature, may be mixed and matched by one of ordinary skill in this art to construct additional systems and techniques in accordance with principles of this disclosure. It is, therefore, to be understood that the appended claims are intended to cover all such modifications and changes as fall within the true spirit of the invention.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An AC-DC power converter comprising:
an electrical terminal comprising a positive node and a negative node;
a first switch coupled across the positive node and the negative node;
a second switch coupled in a reverse orientation relative to the first switch and in parallel to the first switch forming a first path and a second path;
a first electrical storage device situated in the first path; and
a second electrical storage device situated in the second path.

2. The power converter of claim 1, wherein the electrical terminal comprises an output terminal.

3. The power converter of claim 1, wherein the first and second switches comprise insulated gate bipolar transistors.

4. The power converter of claim 1, wherein the first and second electrical storage devices comprise capacitors.

5. A power conversion system comprising;
phase units wherein each phase unit comprises an upper converter arm and a lower converter arm configured to convert power for a distinct phase of an input power,
wherein each converter arm comprises power modules coupled in series to each other and each module comprises a power converter,
wherein each power converter comprises an electrical terminal comprising a positive node and a negative node,
a first switch coupled across the positive node and the negative node,
a second switch coupled in a reverse orientation relative to the first switch and in parallel to the first switch forming a first path and a second path,
a first electrical storage device situated in the first path, and
a second electrical storage device situated in the second path.

6. The system of claim 5, wherein the power conversion system comprises a modular stacked power conversion system.

7. The system of claim 5, wherein the first and second switches comprise insulated gate bipolar transistors.

8. The system of claim 5, wherein the phase units are coupled in parallel to each other.

9. The system of claim 5, wherein the upper converter arm and the lower converter arm are coupled in series to each other.

10. The system of claim 5, wherein the power converter comprises an AC-DC power converter or a DC-AC power converter.

11. The system of claim 5, wherein the power conversion system comprises a three phase power conversion system.
